(19) United States
(12) Patent Application Publication
(10) Pub. No.: US 2005/0109742 A1
(43) Pub. Date: May 26, 2005

(54) Processing method using laser beam

(76) Inventors: Yusuke Nagai, Tokyo (JP); Satoshi Kobayashi, Tokyo (JP); Yukio Morishige, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/972,658

(22) Filed: Oct. 26, 2004

(30) Foreign Application Priority Data
Oct. 27, 2003 (JP) 2003-366173

(51) Int. Cl. B23K 26/06

(52) U.S. Cl. 219/121.73

(57) ABSTRACT

A processing method using a laser beam, which can locate the focus point of a laser beam (82), sufficiently easily and promptly, at a position of a predetermined depth (D) below the face of a workpiece (34). The spacing between a focusing optical system (78) and the face of the workpiece when the laser beam is focused onto the face of the workpiece is adopted as a reference spacing (BL), and the spacing (SL) between the focusing optical system and the face of the workpiece is set based on a set equation taking into consideration the numerical aperture of the focusing optical system and the refractive index of the workpiece in combination with the reference spacing (BL).

### FIELD OF THE INVENTION

This invention relates to a processing method including the step of irradiating a workpiece, such as a semiconductor wafer, with a laser beam, which can pass through the workpiece, to cause deterioration to the workpiece.

### DESCRIPTION OF THE PRIOR ART

In the production of a semiconductor chip, for example, it is well known that the face of a semiconductor wafer is partitioned into a plurality of rectangular regions by streets arranged in a lattice pattern, and a semiconductor circuit is formed in each of the rectangular regions. Then, the semiconductor wafer is cut along the streets to separate the rectangular regions individually to produce semiconductor chips.

Methods using a laser beam have been proposed in recent times as methods for dividing the semiconductor wafer along the streets. In a method disclosed in U.S. Pat. No. 5,826,772, a laser beam applied from the face side of the semiconductor wafer is focused in the vicinity of the face of the semiconductor wafer, and the semiconductor wafer and the laser beam are moved relative to each other along the street, whereby the material on the face side of the semiconductor wafer is melted and removed along the street. In this manner, a groove is formed along the street. Then, an external force is exerted on the semiconductor wafer to break the semiconductor wafer along the street, more specifically, along the groove.

U.S. Pat. No. 6,211,488 and Japanese Patent Application Laid-Open No. 2001-277163 each disclose a method which focuses a laser beam onto an intermediate portion in the thickness direction of the semiconductor wafer, rather than onto the vicinity of the face of the semiconductor wafer, moves the semiconductor wafer and the laser beam relative to each other along the street to generate a deterioration region along the street in the intermediate portion in the thickness direction of the semiconductor wafer, and then exerts an external force on the semiconductor wafer to break the semiconductor wafer along the street, more specifically along the deterioration region.

Furthermore, the specification and drawings of Japanese Patent Application No. 2003-140888, filed by the applicant (the assignee) of the present application, disclose a method which applies a laser beam from the face side of the semiconductor wafer, focuses the laser beam onto the back of the semiconductor wafer or its vicinity, moves the semiconductor wafer and the laser beam relative to each other along the street to generate along the street a deterioration region exposed at the back of the semiconductor wafer, and then exerts an external force on the semiconductor wafer to break the semiconductor wafer along the street, more specifically along the deterioration region.

No matter which of the above-described conventional methods is employed, it is important to focus the laser beam to a predetermined position in the thickness direction of the semiconductor wafer, which is a workpiece, in other words, to locate the focus point of the laser beam at a predetermined depth position below the face of the workpiece. However, the refractive index of the laser beam differs depending on whether the laser beam travels in the air or in the workpiece. For this and other reason, it is not easy to locate the focus point of the laser beam at the above-mentioned position, and this position has been set by an experimental method.

### SUMMARY OF THE INVENTION

It is a principal object of the present invention, therefore, to provide a novel and improved processing method using a laser beam, the processing method being capable of locating the focus point of the laser beam, sufficiently easily and promptly, at a predetermined depth position below the face of a workpiece.

We, the inventors, have found that the above-mentioned principal object can be attained by adopting the spacing between a focusing optical system and the face of a workpiece, when a laser beam is focused onto the face of the workpiece, as a reference spacing, and setting the spacing between the focusing optical system and the face of the workpiece on the basis of a set equation taking into consideration the numerical aperture of the focusing optical system and the refractive index of the workpiece together with the reference spacing.

That is, according to the present invention, as a processing method using a laser beam for solving the aforementioned principal technical challenge, there is provided a processing method using a laser beam, which applies a laser beam capable of passing through a workpiece, held by holding means, to the workpiece by laser beam application means including a focusing optical system, thereby deteriorating the workpiece, comprising:
setting a spacing SL between the focusing optical system and the face of the workpiece based on the following equation 1

$$SL = BL - ( \frac{\sqrt{1 - {P}^{2}}}{\sqrt{{n}^{2} - {P}^{2}}} ) \times D \qquad ( Equation 1 )$$

where BL is a reference spacing between the focusing optical system and the face of the workpiece when the laser beam is focused onto the face of the workpiece, P is the numerical aperture of the focusing optical system, n is the refractive index of the workpiece, and D is the depth of the desired focus point below the face of the workpiece.

In the processing method of the present invention, as long as the relationship between the focusing optical system of the laser beam application means and the workpiece is recognized, the focus point of the laser beam can be located, sufficiently easily and promptly, at a predetermined depth position below the face of the workpiece.

### BRIEF DESCRIPTION OF THE DRAWINGS

FIG. 1 is a perspective view showing the essential parts of a typical example of a processing apparatus which can be preferably used in performing the processing method of the present invention.

FIG. 2 is a perspective view showing a state in which a semiconductor wafer, an example of a workpiece, is mounted on a frame.

FIG. 3 is a schematic diagram showing pulse laser application means.

FIG. 4 is a schematic diagram for illustrating the manner of locating the focus point of a pulse laser beam at a required position.

### DETAILED DESCRIPTION OF THE PREFERRED EMBODIMENTS

Preferred embodiments of a processing method using a laser beam, which is constructed according to the present invention, will now be described in greater detail by reference to the accompanying drawings.

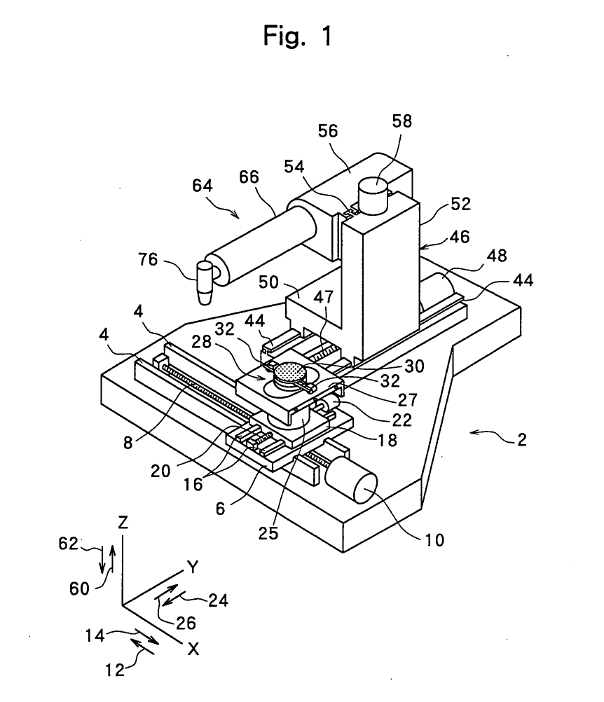

FIG. 1 shows the essential parts of a typical example of a processing apparatus which can be preferably used in performing a processing method constructed in accordance with the present invention. The illustrated processing apparatus has a support base 2, and a pair of guide rails 4 extending in an X-axis direction are disposed on the support base 2. A first slide block 6 is mounted on the guide rails 4 so as to be movable in the X-axis direction. A threaded shaft 8 extending in the X-axis direction is rotatably mounted between the pair of guide rails 4, and an output shaft of a pulse motor 10 is connected to the threaded shaft 8. The first slide block 6 has a downward portion (not shown) extending downwardly, and an internally threaded hole piercing in the X-axis direction is formed in the downward portion. The threaded shaft 8 is screwed to the internally threaded hole. Thus, when the pulse motor 10 is rotated in a normal direction, the first slide block 6 is moved in a direction indicated by an arrow 12. When the pulse motor 10 is rotated in a reverse direction, the first slide block 6 is moved in a direction indicated by an arrow 14. As will become apparent from descriptions to be offered later, the pulse motor 10 and the threaded shaft 8 rotated thereby constitute moving means for moving a workpiece (relative to laser beam processing means).

A pair of guide rails 16 extending in a Y-axis direction are disposed on the first slide block 6. A second slide block 18 is mounted on the guide rails 16 so as to be movable in the Y-axis direction. A threaded shaft 20 extending in the Y-axis direction is rotatably mounted between the pair of guide rails 16, and an output shaft of a pulse motor 22 is connected to the threaded shaft 20. An internally threaded hole piercing in the Y-axis direction is formed in the second slide block 18, and the threaded shaft 20 is screwed to the internally threaded hole. Thus, when the pulse motor 22 is rotated in a normal direction, the second slide block 18 is moved in a direction indicated by an arrow 24. When the pulse motor 22 is rotated in a reverse direction, the second slide block 18 is moved in a direction indicated by an arrow 26. A support table 27 is fixed to the second slide block 18 via a cylindrical member 25, and holding means 28 is also mounted on the second slide block 18 via the cylindrical member 25. The holding means 28 is mounted so as to be rotatable about a central axis extending substantially vertically. A pulse motor (not shown) for rotating the holding means 28 is disposed within the cylindrical member 25. The holding means 28 in the illustrated embodiment is composed of a chuck plate 30 formed from a porous material, and a pair of gripping means 32.

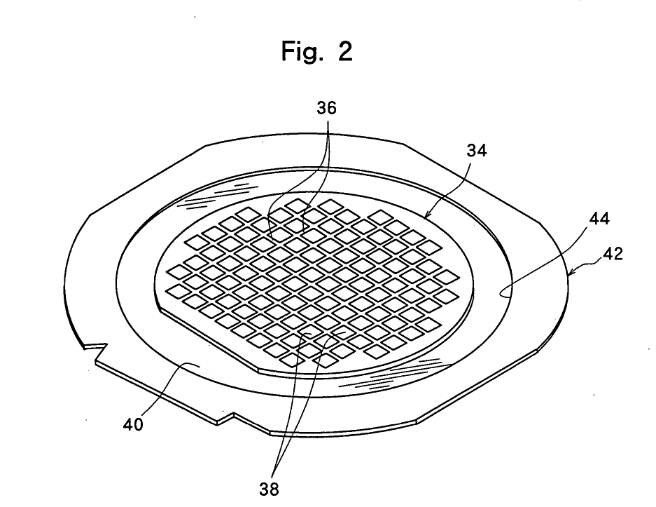

FIG. 2 shows a semiconductor wafer 34 which is a workpiece. The semiconductor wafer 34 is composed of a silicon substrate, and streets 36 are arranged in a lattice pattern on the face of the semiconductor wafer 34. A plurality of rectangular regions 38 are demarcated by the streets 36, and a semiconductor circuit is formed in each of the rectangular regions 38. In the illustrated embodiment, the semiconductor wafer 34 is mounted on a frame 42 via a mounting tape 40. The frame 42, which can be formed from a suitable metal or synthetic resin, has a relatively large circular opening 44 at the center, and the semiconductor wafer 34 is positioned in the opening 44. The mounting tape 40 extends on lower surfaces of the frame 42 and the semiconductor wafer 34 across the opening 44 of the frame 42, and is stuck to the lower surfaces of the frame 42 and the semiconductor wafer 34. In applying a pulse laser beam to the semiconductor wafer 34, the semiconductor wafer 34 is located on the chuck plate 30 in the holding means 28, and the chuck plate 30 is brought into communication with a vacuum source (not shown), whereby the semiconductor wafer 34 is vacuum attracted onto the chuck plate 30. The pair of gripping means 32 of the holding means 28 grip the frame 42. If it is desired to apply the laser beam from the back side of the semiconductor wafer 34, rather than from the face side of the semiconductor wafer 34, it is recommendable to stick a protective tape (not shown) to the face of the semiconductor wafer 34, as desired, turn the frame 42, where the semiconductor wafer 34 is mounted, upside down, and place the frame 42, together with the semiconductor wafer 34, on the chuck plate 30. The holding means 28 itself, and the semiconductor wafer 34 itself mounted on the frame 42 via the mounting tape 40 may be in forms well known among people skilled in the art, and thus detailed explanations for them will be omitted herein.

Referring to FIG. 1 again, a pair of guide rails 44 extending in the Y-axis direction are disposed on the support base 2. A third slide block 46 is mounted on the pair of guide rails 44 so as to be movable in the Y-axis direction. A threaded shaft 47 extending in the Y-axis direction is rotatably mounted between the pair of guide rails 44, and an output shaft of a pulse motor 48 is connected to the threaded shaft 47. The third slide block 46 is nearly L-shaped, and has a horizontal base portion 50, and an upright portion 52 extending upwardly from the horizontal base portion 50. The horizontal base portion 50 has a downward portion (not shown) extending downwardly, and an internally threaded hole piercing in the Y-axis direction is formed in the downward portion. The threaded shaft 47 is screwed to the internally threaded hole. Thus, when the pulse motor 48 is rotated in a normal direction, the third slide block 46 is moved in the direction indicated by the arrow 24. When the pulse motor 48 is rotated in a reverse direction, the third slide block 46 is moved in the direction indicated by the arrow 26.

A pair of guide rails 54 (only one of them is shown in FIG. 1) extending in a Z-axis direction are disposed on one side surface of the upright portion 52 of the third slide block 46. A fourth slide block 56 is mounted on the pair of guide rails 54 so as to be movable in the Z-axis direction. A threaded shaft (not shown) extending in the Z-axis direction is rotatably mounted on one side surface of the third slide block 46, and an output shaft of a pulse motor 58 is connected to the threaded shaft. A protrusion (not shown) projecting toward the upright portion 52 is formed in the fourth slide block 56, and an internally threaded hole piercing in the Z-axis direction is formed in the protrusion. The above-mentioned threaded shaft is screwed to this internally threaded hole. Thus, when the pulse motor 58 is rotated in a normal direction, the fourth slide block 56 is moved in a direction indicated by an arrow 60, namely, is moved upward. When the pulse motor 58 is rotated in a reverse direction, the fourth slide block 56 is moved in a direction indicated by an arrow 62, namely, is moved downward.

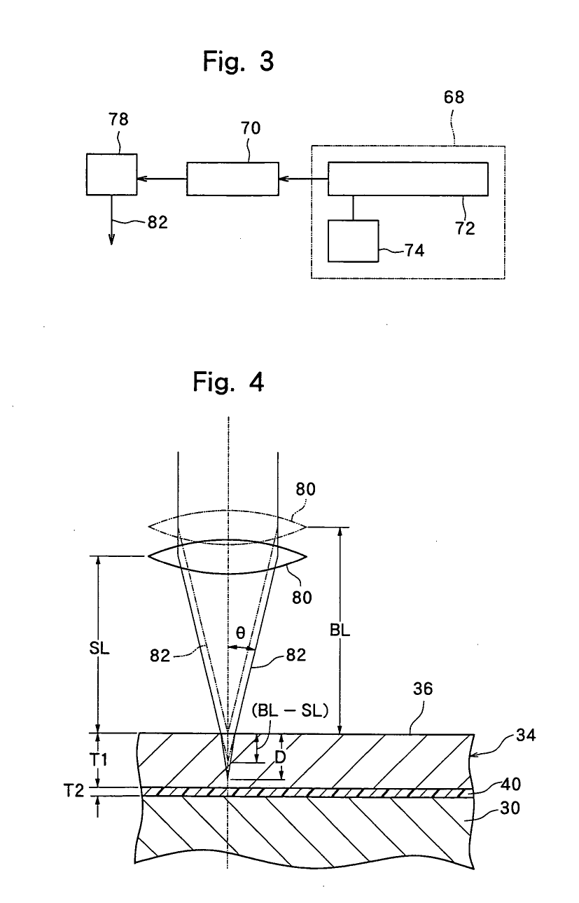

Pulse laser beam application means, indicated entirely at a numeral 64, is mounted on the fourth slide block 56. The illustrated pulse laser beam application means 64 includes a cylindrical casing 66 fixed to the fourth slide block 56 and extending forward (i.e., in the direction indicated by the arrow 24) substantially horizontally. Further with reference to FIG. 3 along with FIG. 1, pulse laser beam oscillation means 68 and a transmission optical system 70 are disposed within the casing 66. The oscillation means 68 is composed of a laser oscillator 72, which is advantageously a YAG laser oscillator or a YVO4 laser oscillator, and a repetition frequency setting means 74 annexed thereto. The transmission optical system 70 includes a suitable optical element such as a beam splitter. An applicator head 76 is fixed to the front end of the casing 66, and a focusing optical system 78 is disposed within the applicator head 76.

With reference to FIG. 4 along with FIGS. 1 to 3, the focusing optical system 78 includes an objective lens, i.e., a focusing lens 80. Through this focusing lens 80, a pulse laser beam 82 is directed at the semiconductor wafer 34 at the street 36. If it is desired for the pulse laser beam 82 to be focused to a position at a depth D below the face of the semiconductor wafer 34 at the street 36, a spacing SL between the focusing lens 80 of the focusing optical system 78 and the face of the semiconductor wafer 34 at the street 36 is set, in the processing method according to the present invention, based on the following equation 1:

$$SL = BL - ( \frac{\sqrt{1 - {P}^{2}}}{\sqrt{{n}^{2} - {P}^{2}}} ) \times D \qquad ( Equation 1 )$$

In the above equation, BL is a reference spacing BL between the focusing lens 80 and the street 36 of the semiconductor wafer 34 when the pulse laser beam 82 is focused onto the face of the semiconductor wafer 34 at the street 36, and takes a predetermined value dependent on the focal length of the focusing lens 80. P is the numerical aperture of the focusing optical system 78, and takes a predetermined value dependent on the focusing optical system 78 used. n is the refractive index n of the semiconductor wafer 36, and takes a predetermined value dependent on the material for the semiconductor wafer 36. If the numerical aperture P is designated as sin θ, the above equation 1 can be expressed as the following equation 2:

$$SL = BL - ( \frac{cos θ}{\sqrt{{n}^{2} - {sin}^{2} θ}} ) \times D \qquad ( Equation 2 )$$

The above-mentioned reference spacing BL is the same as the spacing between the focusing lens 80 and the surface of the chuck plate 30 when the pulse laser beam 82 is focused onto the surface of the chuck plate 30 (this spacing has a predetermined value which can be recognized beforehand in a particular processing apparatus). Let the thickness of the semiconductor wafer 34 at the street 36 be T1, and the thickness of the mounting tape 40 be T2. If the focusing lens 80 is positioned at a distance, BL+(T1+T2), from the surface of the chuck plate 30, the spacing between the focusing lens 80 and the face of the semiconductor wafer 34 at the street 36 is the reference spacing BL. In the processing method of the present invention, therefore, it is vital to recognize the sum of the thickness T1 of the semiconductor wafer 34, which is the workpiece, at the street 36 and the thickness T2 of the mounting tape 40. Simply by so doing, it becomes possible to carry out the positioning of the focusing lens 80 for achieving the set spacing SL determined by the aforementioned equation (1) or (2), accordingly, the positioning of the pulse laser beam application means 64 in the directions indicated by the arrows 60 and 62 (FIG. 1). Thus, the pulse laser beam 82 can be focused, sufficiently easily and promptly, to the position at the required depth D below the face of the street 36 in the semiconductor wafer 34. If the sum of the thickness T1 of the semiconductor wafer 34 at the street 36 and the thickness T2 of the mounting tape 40 is not known beforehand, this sum can be recognized, for example, by making actual measurements before placing the semiconductor wafer 34 on the chuck plate 30. Alternatively, after the semiconductor wafer 34 is placed on the chuck plate 30, the length from a suitable measuring instrument (not shown), such as a laser measuring instrument, to the surface of the chuck plate 30, and the length from the measuring instrument to the face of the semiconductor wafer 34 at the street 36 may be actually measured by the measuring instrument. The sum of the thickness T1 of the semiconductor wafer 34 at the street 36 and the thickness T2 of the mounting tape 40 can be determined from the measured values. Particularly if the thickness T1 of the semiconductor wafer 34 at the street 36 is not constant, but varies along the street 36, it is desirable to make the actual measurement by the above measuring instrument. In this case, when the semiconductor wafer 34 is moved along the street 36 relative to the pulse laser beam 82, the above set spacing SL is changed, as appropriate, in accordance with changes in the thickness T1 of the semiconductor wafer 34, whereby the depth D of the focus point can be adjusted to the desired value.

When the pulse laser beam 82 is focused to the position at the depth D below the face of the semiconductor wafer 34, a deterioration region (such a deterioration region is, for example, a region of melting and resolidification) is generated in the semiconductor wafer 34 in surrounding areas of approximately the depth D. Thus, when the semiconductor wafer 34 and the pulse laser beam 82 are moved relative to each other along the street 36, for example, by moving the holding means 28 in the direction indicated by the arrow 12 or 14 (FIG. 1), the deterioration region is generated in the semiconductor wafer 34 along the street 36. In the deterioration region, the strength is locally decreased. Thus, the semiconductor wafer 34 can be broken along the street 36 by exerting a suitable external force on the semiconductor wafer 34.

1. A processing method using a laser beam, which applies a laser beam capable of passing through a workpiece, held by holding means, to said workpiece by laser beam application means including a focusing optical system, thereby deteriorating said workpiece, comprising:
setting a spacing SL between said focusing optical system and a face of said workpiece based on the following equation 1
$$SL = BL - ( \frac{\sqrt{1 - {P}^{2}}}{\sqrt{{n}^{2} - {P}^{2}}} ) \times D \qquad ( Equation 1 )$$
where BL is a reference spacing between said focusing optical system and said face of said workpiece when said laser beam is focused onto said face of said workpiece, P is a numerical aperture of said focusing optical system, n is a refractive index of said workpiece, and D is a depth of a desired focus point below said face of said workpiece.
